(19) United States
(12) Patent Application Publication
(10) Pub. No.: US 2025/0016160 A1
(43) Pub. Date: Jan. 9, 2025

(54) COMPUTING SYSTEM SUPPORTING RELIABLE ACCESS TO A WEBSITE

(71) Applicant: vidby AG, Rotkreuz (CH)

(72) Inventor: Oleksandr KONOVALOV, Steinhausen (CH)

(73) Assignee: vidby AG, Rotkreuz (CH)

(21) Appl. No.: 18/347,213

(22) Filed: Jul. 5, 2023

(51) Int. Cl. H04L 9/40; G06F 16/955

(52) U.S. Cl. CPC H04L 63/101; G06F 16/9566

(57) ABSTRACT

A computing system supports reliable access to a website, and comprises a server comprising a processing unit, and a database. The processing unit can provide a registration interface to enable a requester to register a URL representing a website, register a URL by assigning a code to the URL, the code identifying the URL, and by storing the URL and the assigned code in the database, and supply the code to the requester responsive to registering a URL. The processing unit can provide a website access interface to enable a user to access a website registered in the database by entering a code different to a URL of the website, verify if the entered code is stored in the database in response to the code being entered in the website access, and provide access to the user to the URL assigned to the entered code if stored in the database.

### BACKGROUND OF THE INVENTION

The invention relates to a computing system and a method for supporting reliable access to a website.

Today's personal and business life includes clicking on a multitude of links in the World Wide Web. Many of them are clicked for the first time, many originators of such links are unknown to the person clicking.

Opening unknown links can expose data of the user of such link to significant vulnerabilities. Malicious links may lead to websites or downloads that contain malware or viruses. These harmful programs can infect the user's device/computer, allowing hackers to gain unauthorized access to the user's personal or business data.

Sending malicious links while pretending to have a different identity is also referred to as “link spoofing”, or “phishing links”. Under the guise of a company's known brand such as the brand of a bank, an insurance company, a delivery service, an authority, etc., hackers send links to users which links are not the original links of such brands, but different, malicious links linking to malware used to subsequently gain access to users' personal data.

Exposing personal or business data to unknown websites and, thus, revealing sensitive information can lead to identity theft, financial loss, and the potential misuse of personal or sensitive information. Hackers may use these data or credentials to gain unauthorized access to the victim's accounts.

Most of commercial data requires security measures. Sharing commercial data via unknown links does not provide for the desired security for such data.

Hence, it is a general object of the invention to provide a more reliable way to trust in links received.

### BRIEF SUMMARY OF THE INVENTION

Accordingly, a computing system is provided for supporting reliable access to a website. The computing system comprises a server comprising a processing unit, and a database. The processing unit is configured to provide a registration interface configured to enable a requester to register a URL representing a website; to register a URL by assigning a code to the URL, the code identifying the URL, and by storing the URL and the assigned code in the database; and to supply the code to the requester in response to registering a URL. The processing unit is further configured to provide a website access interface configured to enable a user to access a website registered in the database by entering a code different to a URL of the website; in response to the code being entered in the website access interface verify if the entered code is stored in the database; and to provide the user access to the URL assigned to the entered code if the entered code is stored in the database.

A method is provided for supporting reliable access to a website. The method comprises providing a registration interface enabling a requester to register a URL representing a website; registering a URL by assigning a code to the URL, the code identifying the URL, and by storing the URL and the assigned code; supplying the assigned code to the requester. The method further comprises providing a website access interface enabling a user to access a website by entering a code different to a URL of the website; verifying if a code entered in the website access interface is assigned to a registered URL; if so providing the user access to the URL assigned to the entered code.

A computer program product is provided comprising computer program code configured to implement a method according to any of the method embodiments when executed on a processing unit.

### BRIEF DESCRIPTION OF THE DRAWINGS

The invention will be better understood when consideration is given to the following detailed description thereof. Such description makes reference to the annexed drawings, wherein:

FIG. 1 illustrates a block diagram including a computing system according to an embodiment of the present invention;

FIG. 2 illustrates a sample web access interface as used in an embodiment of a computing system and/or a method of the invention;

FIG. 3 illustrates a flow diagram representing a method according to an embodiment of the present invention.

### DETAILED DESCRIPTION OF THE INVENTION

The following terms are defined: A website represents a document callable from the Internet. The document is stored at a specific location in the Internet, typically a server. The location the document is stored is coded, in combination with other information such as applicable protocol, into a URL (Uniform Resource Locator) which, when entered into a browser of a user's device such as a desktop, laptop or tablet computer, or a smartphone, retrieves the location of the document and presents the content of the document in the browser. A link is understood as the URL of a website or a different representation of the URL to click on and open the corresponding website. Links may be presented to users in websites, or may be sent in emails, chats, etc. and as thus are made available to others. The purpose of sending links to others may include pointing to commercial offerings of the sender, offering information provided by a website the link refers to, etc.

Prior to describing embodiments illustrated in the Figures, it is related to more general aspects and embodiments of the present invention.

A computing system is introduced that supports reliable access to a website. Accordingly, this computing system enhances the likelihood to access the correct URL of a website intended to visit, rather than a malicious, spoofed one.

The computing system at least comprises a server and a database. The database may be part of the server, e.g. being represented by a storage of the server. In a different embodiment, the database is a unit separate from the server, possibly located remote from the server, however connected to the server for interaction purposes. A server may also be represented by a server system containing one or more individual servers, wherein the workload may be distributed amongst such individual servers as desired. The individual servers of such a computing system may be distributed in a sense that the individual servers reside at different locations, e.g. around the world. In the same way, the computing system may comprise more than one database, possible also in a distributed arrangement. The or each server has a processing unit configured to process tasks assigned to the server/s within the scope of the present teaching.

The processing unit is configured to provide a registration interface configured to enable a requester to register a URL representing a website. Preferably, the registration interface is a user interface to interact with a specific user group, i.e. requesters. Requesters are considered to be parties or persons interested in registering their websites for the service offered on/by the computing system, and, hence, interested in promoting credibility of their brands and offering secure access to their websites to users such as customers. In a preferred embodiment, the registration interface is a web interface, e.g. a webpage of the service provider popping up at the computer of the requester in response to calling the corresponding URL of the service. Preferably, the registration interface is configured to prompt the requester to at least enter the URL to be registered by the requester, e.g. via a prompt.

Preferably, the registration interface may ask a first-time-requester to first register in case the registration service only is applicable to registered requesters. Accordingly, personal data of the person or legal entity representing a requester are to be deposited with the service, e.g. to be stored at the or another database of the computing system prior to the requester being entitled to request for registering a URL. A corresponding registration process may be run through prior to registering any URL, and corresponding requester data, such as but not limited to name, address, identifier/s, VAT number, type of business, etc., may be requested from the requester via the registration interface, e.g. via prompts. The filled in requester data then may be stored as indicated above.

While not every request for registering a URL necessarily leads to a registered URL, in the following it assumed that a request for registering a URL may be approved while criteria for approval or disapproval may be indicted further below.

In case a URL is approved for registry, the processing unit assigns a code to the URL. The code is a code different from the URL, hence, does not follow the nomenclature of URLs which rather serve to indicate the location in the web the requested resource can be retrieved from. The code may have a defined amount of digits, for example, and may comprise letters, numbers and/or special characters. The code identifies the URL. Accordingly, it is assumed that the code is a unique identifier for the URL, i.e. no code is assigned to more than one URL, and no URL is assigned to more than one code. Preferably, the computing system or the corresponding service provider is the owner of the codes and is responsible for maintenance and safeguarding that the 1:1 relationship is maintained between codes and URLs. Accordingly, the computing system preferably generates the codes, and maintains the codes. While it is preferred that only valid codes are stored in the database, in a different embodiment, a distinction may be made between valid and invalid codes, at least the codes of one of these categories may be flagged. Invalid codes may, e.g., be codes used previously but not being presently assigned to registered URLs. In such system, codes may be re-assigned to new URLs in case one or more of a previously registered URL no longer exists, the owner or requester for the corresponding URL no longer exists, a subscription for the service was terminated or expired or not renewed, a requester withdrew from the service, etc.

Registering a URL comprises not only the assignment of a code to the URL but also storing a pair of URL and assigned code in the database. Other information may be assigned and stored in combination with said pair, if desired, such as requester information.

The assigned code is supplied to the requester. Preferably, the assigned code is supplied to the requester via the registration interface. For example, in response to a successful registration, the web interface may confirm registration and display the code for the registered URL to the requester. In a different embodiment, the code may be sent to the requester by email, SMS or other text message format, i.e. by means of a channel different to the registration interface.

The computing system also provides a website access interface configured to enable a user to access a website registered with the service. The website access interface may again be a web interface. In one embodiment, it may be separate from the registration interface; in another embodiment, the registration interface and the website access interface is a combined interface, preferably a combined web interface.

The requester for registering a URL typically is a company or other person maintaining a website represented by the URL for doing business, such as offering and/or selling goods, offering and/or selling services, providing information, etc. A user of the present service most often is a customer or potential customer of the requester, i.e. a person making use of or being interested in making use of the online services of the requester. Hence, the requester interface typically is directed at a different target group than the website access interface. As a result, these interfaces may preferably be separate from each other, and may also be callable at different subdomains of the domain of the present service. However, there may be scenarios where a common interface is desired implementing both functionalities.

In the website access interface, the user is offered or prompted to enter a code which may be assigned to a registered URL. In response to the code being entered in the website access interface it is verified if the entered code is stored in the database. Typically, if the entered code is not stored in the database, a message may be returned to the user via the website access interface, that no such code exists or that no URL is validly assigned to this code.

Hence, the code does not identify a URL. However, in case the entered code is retrieved from the database, which implies that the code is valid and a corresponding URL is registered, the user is given access to the assigned URL. This means, in turn, that the user is assured to access an original website instead of a malicious website claiming to be an original one.

Accordingly, the computing system may be considered as a verification center for URLs, or, in case URLs are considered as (web-) links to be distributed in the World Wide Web, as link verification center. This verification center preferably checks and verifies URLs and entities such as companies, private persons or developers who maintain URLs and wish to point clients or users to their URL. The registration interface can be considered as API for requesters to generate a code representing their URL and by means of which code finally access is granted to their original URL. The requester may, after having received the code from the service, send the code to the client/user instead of the URL/link. As a result, users, e.g. clients of the requesters, no longer receive links e.g. in emails, chats or other forms of textual communication, but only receive codes to access the URLs through the computing system which acts, as indicated above, as verification center, or in different words, as link certification authority.

Hence, the present invention provides for a robust and secure solution for link sharing. It gives authorized access to shared links through a unique code for each link. Recipient of the code, i.e. the user, and sender of the code, i.e. the requester, are protected both. The recipient is protected from being prevented to access a malicious URL. The requester is protected from damaged reputation in case of its website being misused for spoofing.

In a preferred embodiment, the processing unit is configured to register a URL requested for registration only if one or more verification criteria are fulfilled, else to deny registration. Accordingly, between a request for registration, e.g. finalized by submitting a URL via the registration interface, and the registration, another step may be processed which is a verification of the URL. Such step may be performed automatically by the processing unit, or manually by an operator of the computing system, or semi-automatically by both. Preferably, in such step, and irrespective of the actor, the authenticity of the URL is verified. The URL is only then registered if the verification results in an assumed authenticity of the URL. The triggering for the registration in response to the positive outcome of the verification may be receiving an entry of an operator in a separate operational interface, or may be supplied by the processing unit itself. The authenticity of the URL may be verified according to one or more test calls of the URL and a review of the website presented in response to such test call. And/or it may include the evaluation of requester data either entered during registration of the requester with the service or entered upon requesting registration of the specific URL. It may be, e.g. automatically, verified, if the requester data match with the owner or brand of the URL. Any other authenticity verification may be applied. Any other data than the requester data may also or instead be used for authenticity verification.

Returning to the website access interface, such interface may be a dedicated interface, e.g. a web interface of the service provider offering its services via the computing system or even operating and/or owning the computing system, and e.g. comprise a logo of the service provider and/or a layout of the service provider. In such scenario, the user is requested to open the URL of the service provider and enter the code into a corresponding field or prompt. The user e.g. may copy the code from the email or other text message received from the requester into such website.

In a different embodiment, the field or prompt to enter the code and retrieve access to the corresponding URL is integrated into a different user interface, preferably into a different user web interface, such as preferably into the web interface of a search engine. Given that a search engine provides an input field or input prompt for entering a search string anyway, such field or prompt, e.g. the Google™ or Bing™ search bar, may also be used for entering the code. Preferably, such interface of a search engine is enhanced by a selector configured to select the entry into the search bar to represent a code assigned to a URL according to the specification of the service provider. The selector may be a button or a register in the search engine interface to be operated by the user. Such operation of the selector makes the entered code being handled by the present computing system, and specifically its processing unit, instead of being handled the search algorithm of the search engine. The handling may include passing on the entered code to the entity verifying if the code is a valid code of a registered URL.

In such variant, the search engine user interface preferably is enhanced by program code implementing the selector and its underlying functionality.

The granting or providing of access to the URL assigned to the entered code may include one or more of the following actions, preferably executed by the processing unit:
The URL assigned to the entered code and stored in the database is called from the database.
The website represented by the URL is displayed in a browser opened and/or running on the user's computer.
The URL is sent to the user in form of a link, e.g. via email, other text message, or via the website access interface.

Instead of using the URL stored in the database, the processing unit may also point the user to the correct URL in the web for providing access.

According to another aspect of the invention, a method is provided for supporting reliable access to a website. The method comprises the steps of providing a registration interface enabling a requester to register a URL representing a website. Preferably this step is implemented by a processing unit of a computing system in response to e.g. calling a URL of the corresponding service. In case a URL is to be registered, e.g. in response to a requester requesting registration of a URL via the registration interface, and possibly in response to a positive outcome of a verification process, a code is assigned to the URL, e.g. by the processing unit, and the URL and the assigned code are stored, e.g. in a database of the computing system the processing unit also belongs to. In a next step, or prior to the storage operation, the code assigned to the URL is sent to the requester, e.g. via the registration interface.

In addition, a website access interface is provided which enables a user to access a website by entering a code different to a URL of the website. Accordingly, the code is not the URL but is intended to be the code assigned to the URL during registration. In response to a code being entered by a user in the website access interface, it is verified, preferably by the processing unit, if the entered code is assigned to a registered URL. In other words, it is verified if the entered code is stored in the database representing the registry, and if so access is provided to the URL assigned to the entered code. Accordingly, if the code can be found in the database, it is assumed it is a valid code representing a URL. Providing access to the URL may again include one or more of displaying the website represented by the URL in a browser of the user; sending the URL to the user; sending the URL to the user via the website access interface.

In a preferred embodiment, the URL requested for registration is only registered if one or more verification criteria are fulfilled. Else the registration is denied. Verification criteria applied in the verification process may include a verification of the authenticity of the URL. The authenticity may e.g. be verified by means of requester data supplied by the requester either in a requester registration process or during a URL registration process. In a different embodiment, no verification is applied and the requested URL is registered immediately.

As to the embodiments of the interfaces, it is referred to the foregoing: The website access interface may be a dedicated web interface of the service operating the computing system. Or, the website access interface may be an interface integrated in a web interface of a search engine. In the latter option, the website access interface preferably encompasses a search bar of the search engine for entering the code, and comprises a selector to select the entry into the search bar to represent a code to be passed on to the computing system.

Preferably, from a requester's and a user's point of view, the following steps are performed: The requester requests the registration of a/its URL via the registration interface. The requester receives a code assigned to the URL. The requester submits the code to a user, preferably by email, by a chat messenger, by SMS, or by another text transmission system, e.g. for advertising purposes. A preferred scenario for doing so may be that the user is a client or target audience of the business of the requester, and the requester may wish to advertise products, services, information etc. by pointing to the URL of his/her website. Conventionally he/she would have sent e.g. an advertising email with a link to his/her website. Now, instead of the link, he/she sends the code assigned by the service provider. In response to receiving the code, the user enters the code in the website access interface and gains access to the corresponding website.

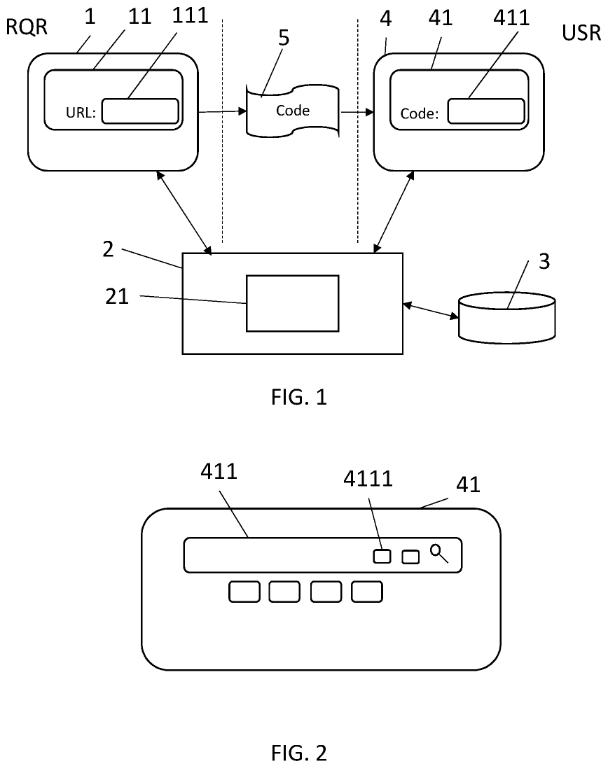

FIG. 1 illustrates a block diagram including a computing system according to an embodiment of the present invention. In FIG. 1, reference sign 1 denotes a computer of a party referred to as requester ROR, reference sign 4 denotes a computer of a party referred to as user USR, and reference sign 2 denotes a server computer which, at least in combination with a database 3 contributes to a computing system according to an embodiment of the present invention. Computer 1 of requester ROR displays a graphical user interface, specifically a web interface, which presently is a requester interface 11 of a service provided by the computing system. Accordingly, it is assumed that the requester ROR has called a URL of the service, specifically a URL providing the requester interface 11. Under the assumption that the requester ROR already is registered with the service and, hence, is allowed to make use of the services of link/URL verification, the present state of the requester interface 11 displays a prompt 111 to enter a URL.

Requester ROR preferably is owner of a website, which website can be displayed in a browser by entering the corresponding URL. Requester ROR is interested in improving his/her client's trust in links pointing to his/her website, which links are distributed within the scope of doing business, e.g. within marketing activities. Accordingly, requester ROR enters/copies the URL of his/her website into the prompt 111. The requester's URL is then available to the processing unit 21, which preferably conducts some authenticity verification for this URL. For example, the processing unit automatically calls the URL provided by the requester ROR via the requester interface 11, and analyses components of the link, e.g. the protocol used, the server hosting the website, the owner registered for the URL, if any, etc. In one embodiment, such verification is automatically conducted by the server 2. In a different embodiment, such verification may be conducted by an operator of the service, hence, a person who finally will enter approval for registering the website or disapproval, preferably via an operator interface.

In any case, if the verification provides a positive result, i.e. the URL is considered as authentic and not malicious, the processing unit 21 registers the URL. For doing so, the processing unit 21 generates a code that is unique for this URL, e.g. code FG56hh!??kj. This code is stored in the database 3 in combination with the URL provided by the requester ROR. At least this pair of information, i.e. the URL and the assigned code contributes to the data stored in a dataset of the database 3. In such database 3, multiple URL/code—combinations are preferably stored. Each stored URL represents an approved request that was deposited at the service. The computing system then submits the code generated for and assigned to the URL of the requester ROR to the requester ROR. Preferably the code is displayed in the requester interface 11.

Later on, the requester ROR may be interested in pointing a potential customer, referred to as user USR in the following, to the products and/or services offered on his/her website. For this reason, the requester would previously have sent an email including the link to/URL of his/her website to the user USR. However, instead of sending the link, the requester ROR now sends the code assigned to the link/URL to the user USR via some message service 5, such as an email, in a chat, per SMS, or in a different way.

User USR receives such email comprising the code. In a next step the user USR enters/copies the code into a prompt 411 of a website access interface 41, preferably being a web interface, displayed in the browser of a user's computer 4. In response to entering the code into the website access interface 41, the code is submitted to the computing system. The computing system verifies, if the code submitted is a valid code representing a URL registered with the service. For doing so, the processing unit 21 queries the database 3 for the code received from the user USR. In case the code is found in the database 3 and is validly assigned to a URL, the verification succeeds and the computing system returns the URL stored in the database 3 to the user USR, i.e. the user's computer 4. Preferably, the URL as stored in the database 3 is called and the corresponding website is shown in a browser on the user's computer 4.

FIG. 2 illustrates a sample website access interface as used in an embodiment of a computing system and/or a method of the invention. This website access interface 41 e.g. is represented by the web interface of a search engine. In this embodiment, a prompt 411 for entering the code is represented by a search bar of the search engine. While upon entering a search string into the search bar of the search engine, the search engine typically searches the web for results matching the search string. However, given that now a code is entered which code only has a meaning in the context of the link verification of the service supported by the computing system, it desirably is communicated to the search engine, via the modified search engine interface, that the entered search string entered is not a search string to search the web for, but is a code in the context of the present service.

Accordingly, it is preferred to provide a selector 4111 in the website access interface 411 that, in response to being operated by the user USR, submits the code to the computing system for being evaluated there. In response to receiving such code in the processing unit 21 of the server 2, the database 3 is queried for the code. In case the code is found in the database 3 as valid code, the assigned URL is returned to the user USR, e.g. by displaying the content of the URL in a browser of the user's computer 4.

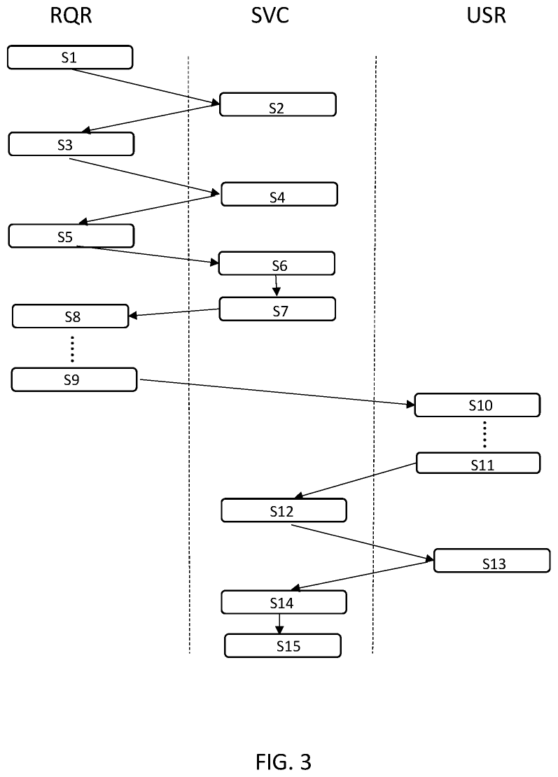

FIG. 3 illustrates a flow diagram representing a method according to an embodiment of the present invention. In step S1, a requester RQR calls the service by entering a URL of a server providing the service SVC into a command line of a browser of a requesters computing device. By doing so, a requester interface provided by the service SVC is displayed to the requester in step S2, and the requester ROR is requested to enter login data to register with the service SVC. In step S3, the requester ROR registers with the service SVC by entering requester data, such as company name, address, etc., In step S4, the service SVC registers the requester ROR as a registered user of the service SVC. The service SVC, in the requester interface, displays a prompt to enter a URL the requester ROR desires to register. In step S5, the requester ROR enters his/her URL. In step S6, the service SVC verifies the entered URL, e.g. on the basis of the requester data. In case of a positive result of the verification, the service SVC registers the URL in step S7 by generating a code, assigning the code to the URL, and storing the URL and the assigned code in a database. In step S8, the code is submitted to the requester ROR via the requester interface.

Later on, the requester ROR desires to point a user USR to his/her website, e.g. for displaying the latest offerings. For this reason, in step S9, the requester ROR sends an email including the code to the user USR. In step S10, the user USR receives this email.

At some point in time after having received the email from the requester ROR, the user USR decides to look at the offering from requester ROR. For this reason, the user USR calls a website access interface of the service SVC in step S11. In step S12, the website access interface is supplied to the user USR and the user is prompted to enter a code. In step S13, the user USR enters the code and submits the code to the service SVC represented by the computing system. In step S14, the computing system verifies the code by searching for the code in the database of valid codes. In case of the code being found in the database, the computing system returns the URL assigned to the code to the user USR in step S15. This link is a link verified by the service SVC, such that the user USR can open the link without any security issues involved.

While there are shown and described presently preferred embodiments of the invention, it is to be distinctly understood that the invention is not limited thereto but may be otherwise variously embodied and practised within the scope of the following claims.

1. Computing system supporting reliable access to a website, comprising
a server comprising a processing unit, and
a database,
wherein the processing unit is configured to:
provide a registration interface configured to enable a requester to register a URL representing a website,
register a URL by assigning a code to the URL, the code identifying the URL, and by storing the URL and the assigned code in the database,
in response to registering a URL supply the code to the requester,
provide a website access interface configured to enable a user to access a website registered in the database by entering a code different to a URL of the website,
in response to a code being entered in the website access interface verify if the entered code is stored in the database,
if the entered code is stored in the database provide access to the URL corresponding to the entered code to the user.

2. Computing system according to claim 1,
wherein the processing unit is configured to register a URL requested for registration only if one or more verification criteria are fulfilled, else deny registration.

3. Computing system according to claim 1,
wherein the processing unit is configured to generate the code,
wherein the processing unit is configured to supply the code to the requester via the registration interface.

4. Computing system according to claim 1,
wherein the registration interface is configured to prompt the requester to enter a URL to be registered,
wherein the registration interface is a web interface.

5. Computing system according to claim 1,
wherein the processing unit is configured to, in response to receiving a URL via the registration interface:
verify authenticity of the URL, and
register the URL only if the verification results in an assumed authenticity of the URL.

6. Computing system according to claim 1,
wherein the registration interface is configured to prompt the requester to enter the URL to be registered and to enter requester data,
wherein the processing unit is configured to, in response to receiving a URL and the requester data via the registration interface:
verify authenticity of the URL by means of the requester data, and
register the URL only if the verification results in an assumed authenticity of the URL.

7. Computing system according to claim 1,
wherein the website access interface is a web interface of a service provider offering services by means of the computing system.

8. Computing system according to claim 1,
wherein the website access interface is an interface integrated in a web interface of a search engine.

9. Computing system according to claim 8,
wherein the website access interface comprises a search bar of the search engine for entering the code, and comprises a selector configured to select the entry into the search bar to represent a code to be handled by the computing system.

10. Computing system according to claim 1,
wherein providing access to the URL assigned to the entered code includes one or more of:
calling the stored URL stored;
displaying the website represented by the stored URL in a browser of the user;
sending the stored URL to the user;
sending the stored URL the user via the website access interface.

11. Method for supporting reliable access to a website, comprising:
providing a registration interface enabling a requester to register a URL representing a website,
registering a URL by assigning a code to the URL, the code identifying the URL, and by storing the URL and the assigned code,
supplying the assigned code to the requester,
providing a website access interface enabling a user to access a website by entering a code different to a URL of the website,
verifying if a code entered in the website access interface is assigned to a registered URL,
if so providing access to the URL assigned to the entered code to the user.

12. Method according to claim 11, comprising
registering a URL requested for registration via the registration interface only if one or more verification criteria are fulfilled, else denying registration.

13. Method according to claim 12,
wherein the verification criteria include authenticity of the URL,
preferably wherein the authenticity of the URL is verified by means of requester data.

14. Method according to claim 11, comprising
supplying the code to the requester via the registration interface which registration interface is a web interface.

15. Method according to claim 11,
wherein the website access interface is a web interface of the service offering services by means of the computing system.

16. Method according to claim 11,
wherein the website access interface is an interface integrated in a web interface of a search engine.

17. Method according to claim 16,
wherein the website access interface comprises a search bar of the search engine for entering the code, and comprises a selector configured to select the entry into the search bar to represent a code to be handled by the computing system.

18. Method according to claim 11,
wherein providing access to the URL assigned to the entered code includes one or more of:
calling the stored URL;
displaying the website represented by the stored URL in a browser of the user;
sending the stored URL stored to the user;
sending the stored URL to the user via the website access interface.

19. Method according to claim 11, comprising
a requester requesting the registration of a URL via the registration interface,
the requester receiving a code assigned to the URL,
the requester submitting the code to a user, preferably by email,
the user entering the code in the website access interface and receiving access to the corresponding website.

20. A non-transitory computer readable medium storing a computer program product comprising computer program code configured to implement a method according to claim 11 when executed by a processing unit.
